(19) United States
(12) Patent Application Publication
(10) Pub. No.: US 2025/0391030 A1
(43) Pub. Date: Dec. 25, 2025

(54) DATA OR PATIENT-SPECIFIC VASCULAR SEGMENTATION

(71) Applicant: Siemens Healthineers AG, Forchheim (DE)

(72) Inventors: Philipp Roser, Erlangen (DE); Markus Kowarschik, Erlangen (DE); Annette Birkhold, Stuttgart (DE)

(21) Appl. No.: 19/239,565

(22) Filed: Jun. 16, 2025

(30) Foreign Application Priority Data
Jun. 25, 2024 (DE) 10 2024 205 901.3

(51) Int. Cl. G06T 7/11; G06T 17/00

(52) U.S. Cl. CPC G06T 7/11; G06T 17/00; G06T 2207/20081; G06T 2207/30101

(57) ABSTRACT

Vessels of a biological object are to be reliably segmented. To this end, a method for training a machine learning algorithm for the purpose of segmenting such vessels is proposed. In the method, a 3D reconstruction is provided with the vessels. A starting vascular region is identified in the 3D reconstruction. Subregions that represent a starting vascular segment are extracted from the starting vascular region. The algorithm is trained with the extracted subregions. The trained algorithm is then applied to a first neighboring region, which is adjacent to the starting vascular region. As a result, a first vascular segment is determined in the first neighboring region. Finally, the algorithm is retrained with the first vascular segment determined in the first neighboring region.

The present patent document claims the benefit of German Patent Application No. 10 2024 205 901.3, filed Jun. 25, 2024, which is hereby incorporated by reference in its entirety.

### TECHNICAL FIELD

The present disclosure relates to a method for training a machine learning algorithm for the purpose of segmenting vessels. To this end, a three-dimensional (3D) reconstruction of a biological object with the vessels is provided. Moreover, the present disclosure relates to a method for segmenting vessels, a medical imaging apparatus, and a computer program.

### BACKGROUND

The implementation of a three-dimensional digital subtraction angiography (3D-DSA) is a current method for assessing cerebral vessels, without bones interfering with the visualization. 3D-DSA is based on a first mask run without contrast agent injection. However, from a clinical perspective and in respect of user friendliness, this is not optimal for the following reasons. On the one hand, movements between the recordings may generate unwanted artifacts. On the other hand, the contrast agent injection is matched to the filling image run in terms of time. Furthermore, the entire recording including the filling image run and the mask run takes twice as long. Moreover, an additional dose of x-ray radiation is required for the mask image. This need not necessarily be problematic since the subtraction artifacts may be reduced on account of comparatively few projections. Without a mask image, the number of projections for the filling image would probably need to be increased.

A monitored, trained artificial intelligence (AI) may be used to differentiate bones or vessels from the rest of the image. To this end, marked training data is required. The use of just 3D-DSA as data is not suitable on account of undersampling artifacts. This problem may be avoided by increasing the number of projections and the dose.

An article by Alejandro F. Frangi et al., “Multiscale vessel enhancement filtering,” Medical Image Computing and Computer-Assisted Intervention—MICCAI'98: First International Conference Cambridge, MA, USA, Oct. 11-13, 1998 Proceedings 1, pages 130-137, proposes a model-based method for quantitative 3D-MRA (magnetic resonance angiography). Linear vascular segments are modelled with a central vessel axis curve that is coupled to a surface of a vascular wall. This produces what is known as a “vesselness filter,” which also frequently classifies bones as vessels and in the process overlooks less contrast-rich distal arterial vessels and veins. A further development of the method is described in A. F. Frangi, et al., “Model-based quantitation of 3-D magnetic resonance angiographic images,” IEEE Transactions on Medical Imaging, vol. 18, no. 10, pp. 946-956, October 1999.

### SUMMARY AND DESCRIPTION

The object of the present disclosure includes being able to segment vessels of a biological object in a simpler and thus reliable manner.

The scope of the present disclosure is defined solely by the appended claims and is not affected to any degree by the statements within this summary. The present embodiments may obviate one or more of the drawbacks or limitations in the related art.

In accordance with the disclosure, a method for training a machine learning algorithm for the purpose of segmenting vessels is provided. By way of example, the machine learning algorithm may be an artificial neural network, a support vector machine, or suchlike. Vessels are to be segmented. This means that the vessels are to be detected as related elements on the one hand and to be differentiated from elements, (e.g., bones), which are different to the vessels on the other hand. The vessels are assigned to a biological object, e.g., the brain, the liver, the kidney, etc. The biological object may be part of a human body. However, it may also be part of an animal body or part of a plant.

With the method, a 3D reconstruction of the biological object with the vessels is provided. This 3D reconstruction forms the basis of the segmentation of the vessels. A spatial vascular segmentation based on a 3D vascular image is therefore to take place.

A starting vascular region is identified in the 3D reconstruction. The starting vascular region represents the starting point for the vascular segmentation. The starting vascular region is to be a region of the 3D reconstruction that contains one or more vessels. By way of example, the root of a vascular tree is suitable as a starting vascular region. The starting vascular region is identified manually, automatically, or semi-automatically.

In a further act, subregions that represent a starting vascular segment are extracted from the starting vascular region. So-called “patches,” which represent a vessel or a vascular segment or a part thereof, are therefore extracted from the starting vascular region. This extraction may in turn take place manually, automatically, or semi-automatically.

In a subsequent act, the algorithm with the extracted subregions is trained. The extracted vascular segments in the starting vascular region are therefore machine-learnt by the algorithm.

The thus trained algorithm is then applied to a first neighboring region directly adjacent to the starting vascular region, as a result of which a first vascular segment is determined in the first neighboring region. The trained algorithm is therefore used to identify or segment vascular segments in a neighboring region directly adjoining the starting vascular region. Similarly, the trained algorithm may also be applied to other first neighboring regions that are likewise disposed in the immediate vicinity of the starting vascular region. The trained algorithm may therefore be applied to several neighboring regions of the starting vascular region. In the first neighboring region, one or more first vascular segments are determined with the aid of the algorithm. Similarly, in the other first neighboring regions immediately surrounding the starting vascular region, respective first vascular segments may also be determined or identified with the aid of the trained algorithm.

Finally, the algorithm is retrained with the first vascular segment determined in the first neighboring region. A first vascular segment determined in the first neighboring region may be thinner and may be lower in contrast than a corresponding vascular segment in the starting vascular region. The algorithm is therefore made more sensitive for smaller vessels during retraining, for instance. In particular, during retraining, the algorithm is also matched specifically to the biological object or the patient. Reference may therefore be made to a data-specific or patient-specific training, for instance.

It is therefore advantageously possible to reliably segment vessels without implementing a mask image. The machine learning algorithm used may be trained particularly advantageously on the basis of the 3D data or on a patient-specific basis.

In an exemplary embodiment, provision is made during provision of the 3D reconstruction for the detection of projection images and a 3D reconstruction based thereupon to be carried out. Projection images are therefore detected. The detection may be carried out after contrast agent has been administered. A 3D reconstruction is obtained from the projection images and provided accordingly for the further processing. A very up-to-date 3D reconstruction may thus be made available.

With a further exemplary embodiment, the first vascular segment is determined by identifying corresponding voxels. The first vascular segment and possibly also one or more further vascular segments are identified on the basis of the correspondingly affected voxels. In particular, a quantity of voxels is identified that correspond to the first vascular segment. Voxel-precise vascular segments may therefore be ascertained.

According to a further exemplary embodiment, the starting vascular region or the first vascular segment are identified with a vessel filter. Such a vessel filter is also referred to as “vesselness filter.” It is based on a heuristic approach and highlights tube-like structures. Vascular structures may therefore be reliably identified.

In a further exemplary embodiment, there is provision for the starting vascular region to be identified in the 3D reconstruction by defining a region about a center of gravity that has a high or low intensity in the 3D reconstruction. A center of gravity with a high intensity in the 3D reconstruction is therefore determined, which indicates a high density of vessels or a large vessel filled with contrast agent. This center of gravity therefore represents a region which, with a high degree of certainly, contains a vessel or a plurality of vessels. This vascular region may therefore be used as a starting vascular region, on which the training of the algorithm may be based. The intensity center of gravity therefore reliably characterizes a starting vascular region for the training of the algorithm.

With another exemplary embodiment, the starting vascular region may have several lateral surfaces adjoined by a first neighboring region in each case, for the trained algorithm to be applied to all first neighboring regions and for the corresponding results to be used for retraining purposes. The starting vascular region in the 3D reconstruction therefore represents a starting volume which has several lateral surfaces. For instance, a cuboid has six lateral surfaces as the starting vascular region, whereas a triangular pyramid has four lateral surfaces as the starting vascular region. Other bodies may also be used as the starting vascular region. A first neighboring region adjoins several lateral surfaces of the starting vascular region in each case. If necessary, respective first neighboring regions directly adjoin all lateral surfaces. The algorithm trained with the aid of the starting vascular region is now applied to all first neighboring regions. The results of the segmentations of the neighboring regions are then used to retrain the algorithm. The algorithm is therefore trained outwardly from the center, since the result in the center is the most reliable and the segmentation results are correspondingly less reliable in the further outwardly lying neighboring regions, in which the vessels are smaller and the contrast agent concentrations are lower.

According to a further development, a second neighboring region directly adjoins several lateral surfaces of the first neighboring regions in each case. Each second neighboring region may be further away from the center of the starting vascular region than each first neighboring region. The second neighboring regions therefore surround the first neighboring regions and these in turn the starting vascular region in a similar manner to an onion. With a special embodiment, second neighboring regions directly adjoin all lateral surfaces of the first neighboring regions that point away from the center.

According to a further exemplary embodiment, the trained algorithm may be applied to one (or more) of the second neighboring regions directly adjacent to the first neighboring region and the center of gravity of which is further away from the center of the starting vascular region than a center of gravity of the first neighboring region, as a result of which a second vascular segment (or more) is determined in the second neighboring region, wherein the algorithm is retrained with the second vascular segment determined in the second neighboring region. Vascular segments are therefore identified in the respective neighboring regions and used for retraining. The application of the algorithm and the retraining, as already implemented in respect of the first neighboring region, is therefore repeated in respect of the second neighboring region. The algorithm is therefore further refined.

In one exemplary embodiment, the starting vascular region is a cuboid or a cube, and the first neighboring region directly adjoins a lateral surface of the cuboid. The first neighboring region therefore directly adjoins a corresponding side of the starting vascular region with one side. The entire 3D reconstruction may be easily divided into the respective regions with cubes.

In one exemplary embodiment, the second neighboring region only makes contact with a single edge of the cuboid of the starting vascular region. This means that, in the case of the cuboid-shaped division of the 3D reconstruction, the second neighboring region not only directly adjoins a side of the first neighboring region but also makes contact with an edge of the cuboid of the starting vascular region. Therefore, the volume around the starting vascular region may be completely filled by respective neighboring regions.

According to a further exemplary embodiment, the second neighboring region is in contact with in each case one side of the first neighboring region and a further first neighboring region, which likewise directly adjoins the starting vascular region. This means that the second neighboring region with at least two sides adjoins one of two first neighboring regions in each case. In this way, the volume of the 3D construction may be completely divided into the respective regions.

As described above, the retraining of the algorithm in respect of second neighboring regions is repeated in order to achieve a refinement of the algorithm. A repetition of this type may be extended on the basis of the starting vascular region beyond the first neighboring regions and the second neighboring regions outward to third neighboring regions, etc. Accordingly, with one exemplary embodiment, the algorithm trained as above may be applied to one (or more) third neighboring regions directly adjacent to one of the second neighboring regions, and the center of gravity of which is further from the center of the starting vascular region than a center of gravity of the second neighboring region, as a result of which a third vascular segment (or more) is determined in the third neighboring region, wherein the algorithm is retrained with the third vascular segment determined in the third neighboring region. In this way, the algorithm continues to be refined further outward and may thus also reliably segment smaller vessels, which are less rich in contrast.

According to a further exemplary embodiment, provision is made for one of the neighboring regions, which is further away from the starting vascular region than another of the neighboring regions, to be smaller than the other neighboring region. This means that the neighboring regions may become outwardly ever smaller (starting from the starting vascular region). This is particularly advantageous when the vessels become outwardly ever smaller and the segmentation has to be ever finer.

With another exemplary embodiment, the method is combined with a graph-based method in order to determine respective vascular segments. The graph-based method is based on the graph theory, according to which possible structures are represented by nodes and edges. A method of this type may act here in a supporting manner since the vascular segments have to pass into one another at the region borders.

With a further exemplary embodiment, provision is made for at least one part of a neighboring region also to be used when respectively applying or retraining the algorithm, said training region already having been used with an earlier retraining. This means that with the application or retraining of the algorithm, regions that overlap with parts of the training cohort are used. An improved continuity may be achieved in this way.

According to a further exemplary embodiment, provision is made for the 3D reconstruction to be provided in a time-resolved manner, and for the extraction of the subregions and/or the determination of the first vascular segment (also) to take place as a function of intensity fluctuations in corresponding voxels. In this case, a time-resolved 3D reconstruction takes place, which may also be referred to as 4D reconstruction. This takes advantage of the fact that during the natural pulse, e.g. of a patient, vessels change their volume or their diameter, as a result of which the vessel filled with contrast agent shows a corresponding pulsatility. In other words, the intensity of the voxel of the vascular segments changes with the pulse of the vessels. With this temporal information, a distinction may be made between vessels and bones, since bones do not indicate a pulsatility of this type. Accordingly, the pulsatility of the 4D reconstruction may be used to check the plausibility of the vessel classification. Accordingly, the extracted subregions or the determined vascular segments may be classified with more certainty with this information.

According to a further exemplary embodiment, each vascular segment is determined as a function of intensity fluctuations in corresponding voxels. This means that in all neighboring regions, which are defined for training the algorithm, a check is carried out with respect to pulsatility and accordingly for plausibility.

According to the disclosure, a method for segmenting vessels is also provided by applying an algorithm trained as described above to the cited or another 3D reconstruction. This means in particular that the algorithm trained in several iterations may be applied to an overall 3D reconstruction.

Moreover, a medical imaging apparatus with a computing facility is provided and is configured to execute the cited method for segmentation. In particular, the computing facility is able to execute several or all of the acts of the cited training method automatically.

Furthermore, a computer program is also provided. The computer program has commands that, when executed by a medical imaging apparatus as described herein, trigger the apparatus to execute a method as described herein. In certain embodiments, a non-transitory computer readable medium or computer program product having the stored computer program may also be provided.

The algorithms cited above for segmenting vessels may be based on an artificial neural network, a support vector machine, or on another machine learning method.

### BRIEF DESCRIPTION OF THE DRAWINGS

FIG. 1 depicts a schematic view of an example of an imaging apparatus.

FIG. 2 depicts an example of a 3D reconstruction with vascular regions.

FIG. 3 depicts a schematic flow chart of an exemplary embodiment of a method.

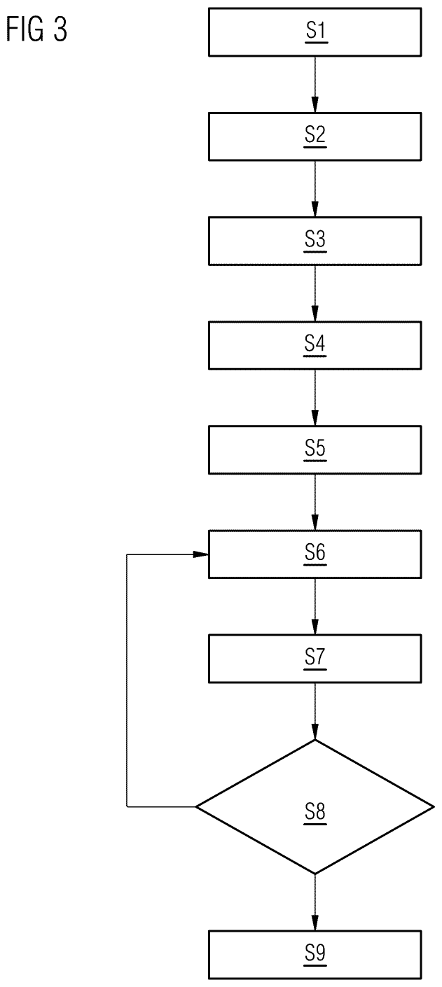

### DETAILED DESCRIPTION

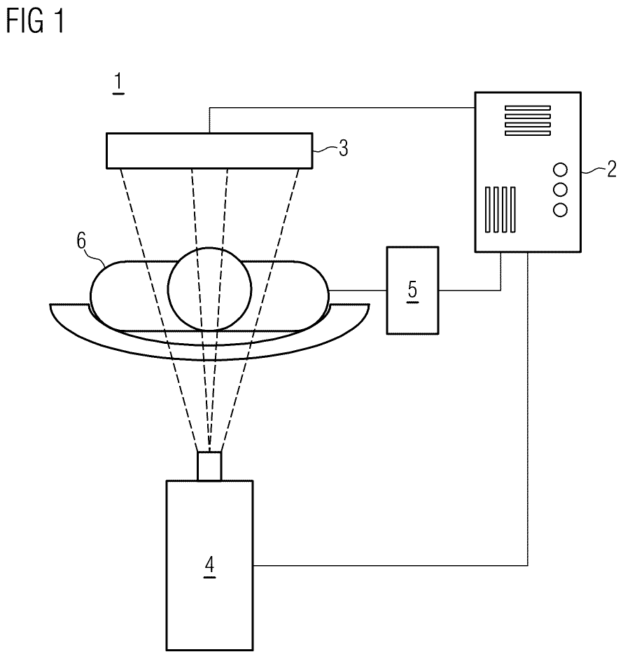

FIG. 1 shows a schematic representation of an exemplary embodiment of an imaging system 1. The imaging system 1 has at least one computing unit 2, a contrast agent injector 5, and an imaging modality, which, in the present example, is designed without restricting generality as an x-ray-based imaging modality, for instance for perfusion imaging or CT angiography or DAS (Digital subtraction angiography) and has an x-ray source 4 and an x-ray detector 3.

The at least one computing unit 2 is configured to implement a method for segmenting in particular vessels in 3D or 4D reconstructions.

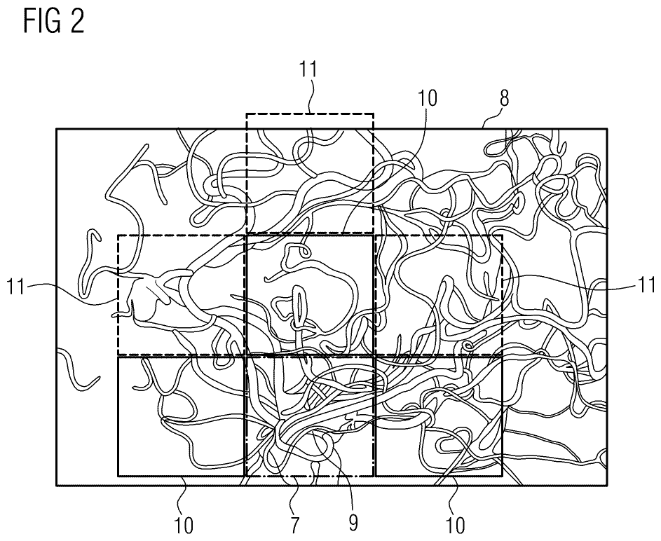

Certain organs in living beings indicate tree-like vascular structures. On the basis of a thicker vessel, an increasing number of subvessels branch outward. The greater the distance from the main vessel, the finer the individual vessels. This is also the case in the brain of a human, for instance. FIG. 2 shows a corresponding vascular structure of a human brain.

In certain examples, vascular structures of this type also occur in other organs, which have what are known as a convex design. Convex objects of this type would also be the liver or other inner organs as well as individual limbs, for instance.

With the subsequent exemplary embodiment, projection images are detected in act S1 of the method. In particular, a set of contrast-enhanced projection images is obtained with the imaging apparatus in FIG. 1, for instance. The projection images may also be provided another way.

In act S2, a 3D reconstruction from the projection images takes place. FIG. 2 shows such a 3D reconstruction of the vessels of a brain. If necessary, the projection images are also temporally resolved in act S1 and a 4D reconstruction is carried out in act S2, e.g., a temporally variable 3D reconstruction. Therefore at least one 3D reconstruction of a biological object (here: brain) with vessels may thus be provided. However, the 3D or 4D reconstruction may also be provided by data carriers, networks and suchlike.

In act S3, a starting vascular region 7 is identified in the 3D reconstruction 8. The starting vascular region 7 is identified by a “certain” vessel 9 for instance. The certain vessel 9 is the largest vessel or the largest vascular accumulation in the 3D reconstruction 8, for instance. This large vessel or this large vascular accumulation may be used as a starting point for the training of a segmentation algorithm. The voxels there may namely be certainly assigned to the class “vessel.” The corresponding voxels therefore belong with very high probability to the contrasted vasculature.

This identification of the starting vascular region 7 may be carried out with various methods. By way of example, a strong vessel filter (vesselness filter) may be used, which only responds to large vessels that are rich in contrast. Alternatively, or in addition, a region around a center of gravity with high intensities may be sought in the 3D reconstruction 8 in order to identify the starting vascular region 7. Depending on the imaging, this may naturally also involve a center of gravity with low intensities. A region of interest that may be considered to be the starting vascular region 7 is defined around this center of gravity.

In act S4, the subregions that represent a starting vascular segment are extracted from the starting vascular region. Subregions of this type may also be referred to as “patches.” These subregions represent regions in the 3D reconstruction 8 that represent vessels or parts thereof.

Optionally, a plausibility check may take place at this point in act S5, for instance. The subregions (patches) extracted in act S4 may namely be checked for plausibility for instance, in other words checked to determine whether they pulse in accordance with the heartbeat of a patient. If this is not the case, it is highly probable that this is not a vessel but instead a bone. On the other hand, when the pertinent voxels show pulsating intensity, this is quite likely to be a vessel.

In act S6, the machine learning algorithm may be trained. This algorithm may be based on an artificial neural network or on a support vector machine, for instance. The algorithm is trained with the extracted subregions. In particular, a semantic segmentation algorithm that is based on the identified certain vessel 9 may thus be obtained.

In act S7, the trained algorithm is applied to one or more neighboring regions 10. By way of example, the starting vascular region 7, which encloses the certain vessel 9, is cuboid or cube-shaped. The cube shape of the starting vascular region 7 and the neighboring regions is always assumed to be representative of subsequent views. A neighboring region 10 may adjoin the starting vascular region 7 in all spatial directions in each case. In the specific example of FIG. 2, the starting vascular region 7 is designed as a cube with six sides. Accordingly, a respective first neighboring region 10 may adjoin directly to each side. In the example of FIG. 2, a first neighboring region 10 is missing on the underside of the cube of the starting vascular region 7, since the 3D reconstruction 8 ends at the lower end of the starting vascular region 7. Corresponding first neighboring regions 10 may also adjoin the sides parallel to the image plane, i.e., above and below the image plane.

The previously trained algorithm may now be applied to a first neighboring region 10 (e.g., all neighboring regions), which is directly adjacent to the starting vascular region 7, as a result of which a first vascular segment in the first neighboring region 10 is determined. This means that the segmentation algorithm in the first neighboring region 10 identifies a vessel or a vascular segment. The vessels of the first neighboring regions 10 may still be relatively large so that they are detected with high certainty, although the algorithm has only been trained with the largest vessel or the largest vascular arrangement, i.e., the certain vessel 9.

In act S8, it is now possible to decide whether the training has been completed or not. If not “n,” the method returns to act S6, and a retraining is carried out with the first vascular segments segmented in act S7 in the first neighboring region or in the first neighboring regions.

The acts of the training S6 and the application S7 may be repeated multiple times, wherein with each iteration reference is made to further outer lying neighboring regions.

Therefore, the algorithm trained with the first vascular segment or the several first vascular segments may be applied to second neighboring regions 11, which, in the radial direction, are located further outward starting from the starting vascular region 7. If each second neighboring region 11 is also cube-shaped, it may directly adjoin the sides of the first neighboring regions 10, as indicated in FIG. 2. In particular, a second neighboring region 11 may adjoin each lateral surface of the first neighboring regions 10 that point outwards in respect of the starting vascular region 7. With this arrangement of the cubes, a few second neighboring regions 11 would then make contact with an edge of the cube of the starting vascular region 7, but not its lateral surfaces.

The vessels in the second neighboring regions 11 are in most cases smaller by average than those vessels in the first neighboring regions 10. As the segmentation algorithm is already trained with the vessels of the first neighboring regions 10, in other words less contrast-rich vessels may also be identified, it will also reliably segment the even smaller vessels in the second neighboring regions 11.

These training and application acts may be repeated for so long for instance until the entire 3D reconstruction 8 is segmented. By way of example, third neighboring regions (not shown in FIG. 2) may adjoin to the outside of the second neighboring regions 11. The sequence of repetitions may however also be interrupted according to another criterion, for instance a fixed number.

If the training of the algorithm is completed (“y” in act S8), the algorithm trained at the end according to act S9 may be applied to the entire 3D reconstruction 8 or to another 3D or 4D reconstruction. All regions are segmented here with the algorithm, which is also trained to the finest vessels. The finest vessels are therefore also identified in the starting vascular region 7 and in the first neighboring regions 10 etc.

The training may also be completed if a specific percentage of voxels is identified as vessels or until a predefined condition with respect to a geometric distance is fulfilled.

The segmentation may result in individual vessels not being connected to one another. To avoid this, the connectivity of the identified vessels may be improved in that the segmentation that is based on the trained algorithm is combined with a graph-based method. In this way, a vascular tree with associated vessels may instead be segmented.

In order to further increase the reliability of the segmentation, the original assessment of the certain vessel 9 may be compared with an anatomical atlas. With a further advantageous exemplary embodiment, the neighboring regions to be classified are reduced in size in each iteration of the training. Specifically, the second neighboring region 11 may be smaller than the first neighboring region 10 and the third neighboring region may be smaller than the second neighboring region. The further the neighboring regions lie outside, the smaller therefore their volume. The reduction in size of the regions outward may be associated with the fact that the vessels may become smaller outwards. Moreover, particularly with the brain the outer regions approach the cranial brain so that an improved distinction between bones is enabled with smaller regions at the edge.

With a further exemplary embodiment, the neighboring regions to be classified may be overlayed with parts of the training cohort in each iteration. This means that with each iteration, parts of the newly classified voxel and the voxel used for training purposes are mixed. The newly classified voxels are optionally significantly weighted. The different vessel strengths may also be more reliably segmented.

The method is not restricted to the vascular segmentation in the brain. Instead, the method may also be applied to other body regions, e.g., to the abdomen (such as the liver or organs in the pelvis).

A patient and data-specific semantic segmentation algorithm may therefore be obtained particularly advantageously, and may be iteratively trained and immediately applied to new subsets of the acquired data.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for training a machine learning algorithm for segmenting vessels, the method comprising:
providing a three-dimensional (3D) reconstruction of a biological object with the vessels;
identifying a starting vascular region in the 3D reconstruction;
extracting subregions, which represent a starting vascular segment, from the starting vascular region;
training the machine learning algorithm with the extracted subregions to provide a trained algorithm;
applying the trained algorithm to a first neighboring region, which is directly adjacent to the starting vascular region, as a result of which a first vascular segment is determined in the first neighboring region; and
retraining the machine learning algorithm with the first vascular segment determined in the first neighboring region to provide a retrained algorithm.

2. The method of claim 1, further comprising:
detecting projection images; and
conducting the 3D reconstruction using the detected projection images.

3. The method of claim 1, wherein the first vascular segment is determined by identifying corresponding voxels.

4. The method of claim 1, wherein the starting vascular region or the first vascular segment is identified with a vessel filter.

5. The method of claim 1, wherein the identifying of the starting vascular region in the 3D reconstruction comprises determining a region about a center of gravity that is higher or lower in intensity in the 3D reconstruction.

6. The method of claim 1, wherein the starting vascular region has a number of lateral surfaces,
wherein a respective first neighboring region adjoins each lateral surface of the number of lateral surfaces, and
wherein the trained algorithm is applied to all respective first neighboring regions and the corresponding results are used for retraining.

7. The method of claim 6, wherein a respective second neighboring region adjoins several lateral surfaces of the first neighboring regions directly in each case.

8. The method of claim 7, wherein the retrained algorithm is applied to a second neighboring region of the second neighboring regions, which is directly adjacent to the first neighboring region and a center of gravity of the second neighboring region is further from a center of the starting vascular region than a center of gravity of the first neighboring region, as a result of which a second vascular segment is determined in the second neighboring region, and
wherein the machine learning algorithm is further retrained with the second vascular segment determined in the second neighboring region to provide a further retrained algorithm.

9. The method of claim 8, wherein the determining of the second vascular segment is carried out as a function of intensity fluctuations in corresponding voxels.

10. The method of claim 8, wherein the starting vascular region is a cuboid, and wherein the first neighboring region directly adjoins a lateral surface of the cuboid.

11. The method of claim 10, wherein the second neighboring region only touches a single edge of the cuboid of the starting vascular region.

12. The method of claim 11, wherein the second neighboring region is in contact with in each case one side of the first neighboring region and a further first neighboring region, which likewise directly adjoins the starting vascular region.

13. The method of claim 8, wherein the further retrained algorithm is applied to a third neighboring region, which is directly adjacent to the second neighboring region of the second neighboring regions and a center of gravity of the third neighboring region is further from the center of the starting vascular region than the center of gravity of the second neighboring region, as a result of which a third vascular segment is determined in the third neighboring region, and
wherein the further retrained algorithm is retrained with the third vascular segment determined in the third neighboring region.

14. The method of claim 13, wherein a neighboring region of the first, second, or third neighboring regions, which is further away from the starting vascular region than an additional neighboring region of the first, second, or third neighboring regions, is smaller than the additional neighboring region.

15. The method of claim 1, further comprising:
determining respective vascular segments using the machine learning algorithm and a graph-based method.

16. The method of claim 1, wherein, with the respective application or retraining of the algorithm, at least one part of a neighboring region is also used, which has already been used in an earlier retraining.

17. The method of claim 1, wherein the 3D reconstruction is provided in a time-resolved manner, and
wherein the extracting of the subregions and/or the determining of the first vascular segment is carried out as a function of intensity fluctuations in corresponding voxels.

18. The method of claim 1, further comprising:
applying the retrained algorithm to the 3D reconstruction or another 3D reconstruction.

19. A medical imaging apparatus comprising:
a computing facility configured to:
provide a three-dimensional (3D) reconstruction of a biological object with vessels;
identify a starting vascular region in the 3D reconstruction;
extract subregions, which represent a starting vascular segment, from the starting vascular region;
train a machine learning algorithm with the extracted subregions to provide a trained algorithm;
apply the trained algorithm to a first neighboring region, which is directly adjacent to the starting vascular region, as a result of which a first vascular segment is determined in the first neighboring region;
retrain the machine learning algorithm with the first vascular segment determined in the first neighboring region to provide a retrained algorithm; and
apply the retrained algorithm to the 3D reconstruction or another 3D reconstruction.

20. A non-transitory computer readable medium having a computer program comprising commands, which, upon execution by a medical imaging apparatus, cause the medical imaging apparatus to:
provide a three-dimensional (3D) reconstruction of a biological object with vessels;
identify a starting vascular region in the 3D reconstruction;
extract subregions, which represent a starting vascular segment, from the starting vascular region;
train a machine learning algorithm with the extracted subregions to provide a trained algorithm;
apply the trained algorithm to a first neighboring region, which is directly adjacent to the starting vascular region, as a result of which a first vascular segment is determined in the first neighboring region; and
retrain the machine learning algorithm with the first vascular segment determined in the first neighboring region to provide a retrained algorithm.
